(19) United States
(12) Patent Application Publication
(10) Pub. No.: US 2008/0172884 A1
(43) Pub. Date: Jul. 24, 2008

(54) Folding knife with half handle

(75) Inventor: Yang-Fu Cheng, Taipei (TW)

Correspondence Address: BACON & THOMAS, PLLC, 625 SLATERS LANE, FOURTH FLOOR, ALEXANDRIA, VA, 22314, US

(73) Assignee: KANTAS PRODUCTS CO., LTD., Taipei (TW)

(21) Appl. No.: 11/709,218

(22) Filed: Feb. 22, 2007

(30) Foreign Application Priority Data
Jan. 19, 2007 (TW) 096201059

(51) Int. Cl. B26B 1/02

(52) U.S. Cl. 30/155

(57) ABSTRACT

The present invention is to provide a folding knife comprising an elongate, flat half handle, a blade, a pivot pin for pivotably securing a rear end of the blade to a front end of the half handle, a driven unit mounted proximate to the pivot pin at the rear end of the blade, and a resilient member having a rear end secured to the rear end of the half handle and a front end extending toward the driven unit to urge against the driven unit when the blade is retracted into the half handle, wherein a receiving space is defined by and between the resilient member and the half handle and is adapted to receive a cutting edge of the blade when the blade is retracted into the half handle.

### FIELD OF THE INVENTION

The invention relates to folding knives and more particularly to such a folding knife having a half handle.

### BACKGROUND OF THE INVENTION

There is a rapid, significant progress of technologies in recent several decades. Products related to these technologies include high-technology products as well as consumer goods which are closely tied to our daily life. For having better standards of living, it is desirable among people to improve many kinds of consumer goods by eliminating drawbacks associated therewith. Folding knifes are a typical kind of tool frequently used in our daily life. Particularly, folding knifes are very useful when taking an outdoor activity.

There are many types of folding knifes commercially available. For example, a conventional folding knife 1 is shown in FIG. 1. The folding knife 1 comprises a first half handle 100, a second half handle 101, and a blade 11. The first half handle 100 is adapted to matingly assemble with the second half handle 101 to form a receiving space (not shown) therebetween. The received blade 11 can clear the space defined by the half handles 100 and 101 by pivoting as detailed below. A pivot hole 121 is formed at a rear end of the blade 11. An arcuate recess 111 is formed proximate to the pivot hole 121 at the same side as a cutting edge 110 of the blade 11. A cylindrical pivot 12 having a threaded bore is provided on a rear end of the second half handle 101. A pin (not numbered) having a threaded shank is driven through the pivot hole 121 into the pivot 12 for threadably securing the first half handle 100 to the second half handle 101 and also pivotably securing the blade 11 to the half handles 100 and 101. A resilient member (e.g., torsion spring) 13 is put on the pivot 12 within the space defined by the half handles 100 and 101. The resilient member 13 also urges against a rear portion of the blade 11. A spring depressible push button 14 is provided in the space defined by the half handles 100 and 101 and adjacent the pivot 12. The push button 14 has one end elastically urged against the second half handle 101 and the other end projecting from a surface hole (not numbered) of the first half handle 100 when blade 11 is locked by interlocking the recess 111 and a component of the push button 14. In use, a person may press a projecting portion of the push button 14 to unlock the blade 11. And in turn, the resilient member 13 exerts an expansion force on the blade 11 to quickly eject the blade 11 from the space defined by the half handles 100 and 101. In other words, a simple pressing of the push button 14 by one hand can eject the blade 11 from the folding knife 1 for use.

However, the prior art folding knife 1 suffered from several disadvantages in use. For example, as shown in FIG. 1, the push button 14 projects from the first half handle 100. Thus, it is possible that a person, especially a young child may accidentally press the push button 14 to eject the blade 11 from the knife when holding the knife. Unfortunately, the hand is cut. This can compromise the desired quick use feature of the folding knife 1. Moreover, the resilient member 13 of the folding knife 1 is designed to exert a strong elastic force so as to quickly eject the blade 11 from the half handles 100 and 101 in use. However, it is often that the blade 11 may accidentally eject from the half handles 100 and 101 when, for example the folding knife 1 is placed in the pocket of clothes. As an end, the body is cut by the sharp cutting edge of the folding knife 1. In view of the above, while the folding knife 1 is convenient in use, the folding knife 1 also possesses a potential danger in use. This type of folding knife is of course not complying to the strict safety rules of consumer products.

Referring to FIG. 1 again, for folding the blade 11 within the half handles 100 and 101 or ejecting from same, the rear end of the blade 11 is pivotably provided in the rear of the half handles 100 and 101 and a user has to press the push button 14 to release the stored elastic force of the energized resilient member 13. It is found that the blade 11 will be exposed if only one of the half handles 100 and 101 is employed by the folding knife 1. Also, both the resilient member 13 and the push button 14 cannot be fixed. In brief, the folding knife 1 cannot normally operate by means of the resilient member 13 and the push button 14 by only having a single half handle. Further, such double half handle arrangement cannot reduce the manufacturing cost greatly.

Thus, it is desirable among manufacturers of the art to provide a novel folding knife with only a single half handle and having advantages of being convenient in use, more safe, simplified manufacturing processes, and lower cost in order to overcome the inadequacies of the prior art.

### SUMMARY OF THE INVENTION

After considerable research and experimentation, a folding knife having a single half handle according to the invention has been devised so as to overcome the above drawbacks of the prior art.

It is an object of the invention to provide a folding knife comprising an elongate, flat half handle, a blade, a pivot pin for pivotably securing a rear end of the blade to a front end of the half handle, a driven unit mounted proximate to the pivot pin at the rear end of the blade, and a resilient member having a rear end secured to the rear end of the half handle, and a front end extending toward the driven unit to urge against the driven unit when the blade is retracted into the half handle. A receiving space is defined by and between the resilient member and the half handle. The receiving space is adapted to receive a cutting edge of the blade when the blade is retracted into the half handle. Manipulating the resilient member in cooperation with the driven unit affixed to the blade will eject the blade from the half handle. By utilizing this folding knife, the drawbacks of the prior art can be substantially eliminated. These drawbacks include a single half handle being impossible of assembling with other components in order to effect an ejection of the blade, a single half handle being impossible of retracting the blade into the handle, two half handles being required to assemble with the blade and other components in order to effect an ejection or a retraction of the blade, and the manufacturing cost being increased greatly.

In one aspect of the invention the resilient member is urged against the driven unit for exerting a force to pivot the blade to securely receive the blade in the half handle in a blade retraction operation. To the contrary, pushing the blade to a predetermined position being partially out of the half handle will cause the resilient member to exert an opposite force to pivot and fully eject the blade from the half handle. The invention thus can prevent the blade from being ejected due to vibration or accidental pressing.

The above and other objects, features and advantages of the invention will become apparent from the following detailed description taken with the accompanying drawings.

### BRIEF DESCRIPTION OF THE DRAWINGS

FIG. 1 is an exploded view of a conventional folding knife having a handle consisting of two half handles;

FIG. 2 is an exploded view of a first preferred embodiment of folding knife according to the invention;

FIG. 3 is a side elevation of the assembled folding knife of FIG. 2 where the blade is ejected;

FIG. 4 is an opposite side elevation of the folding knife of FIG. 3 where the blade is retracted;

FIG. 5 is a view similar to FIG. 4 where the blade is ejected;

FIG. 6 is an exploded view of a second preferred embodiment of folding knife according to the invention;

FIG. 7 is a side elevation of the assembled folding knife of FIG. 6 where the blade is retracted;

FIG. 8 is a view similar to FIG. 7 where the blade is ejected; and

FIG. 9 is a side elevation of a third preferred embodiment of folding knife according to the invention where the blade is ejected.

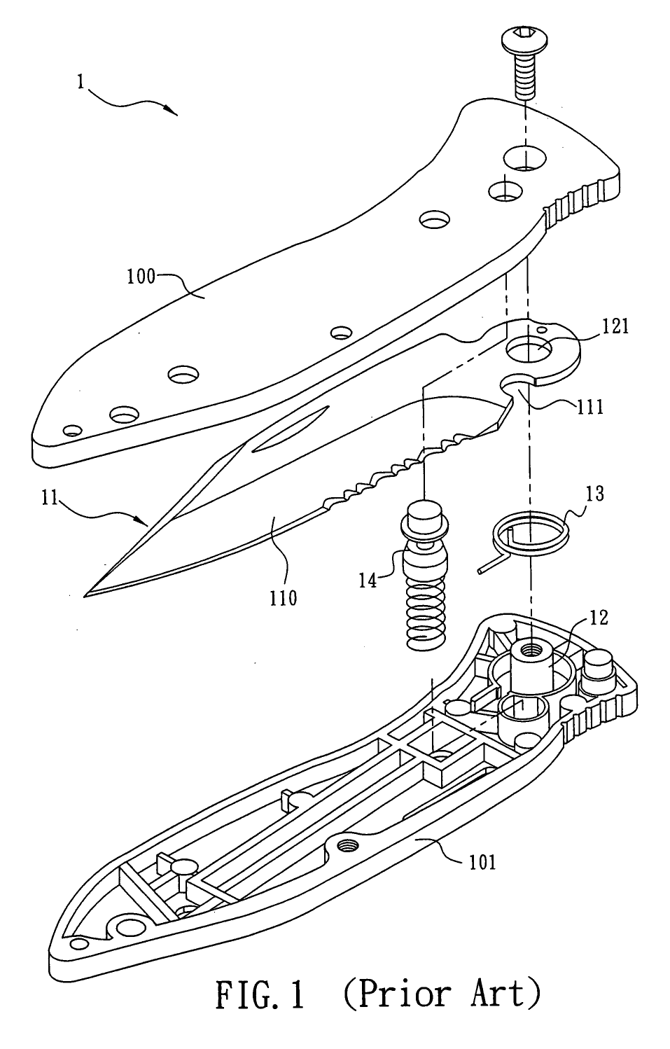

### DETAILED DESCRIPTION OF THE PREFERRED EMBODIMENTS

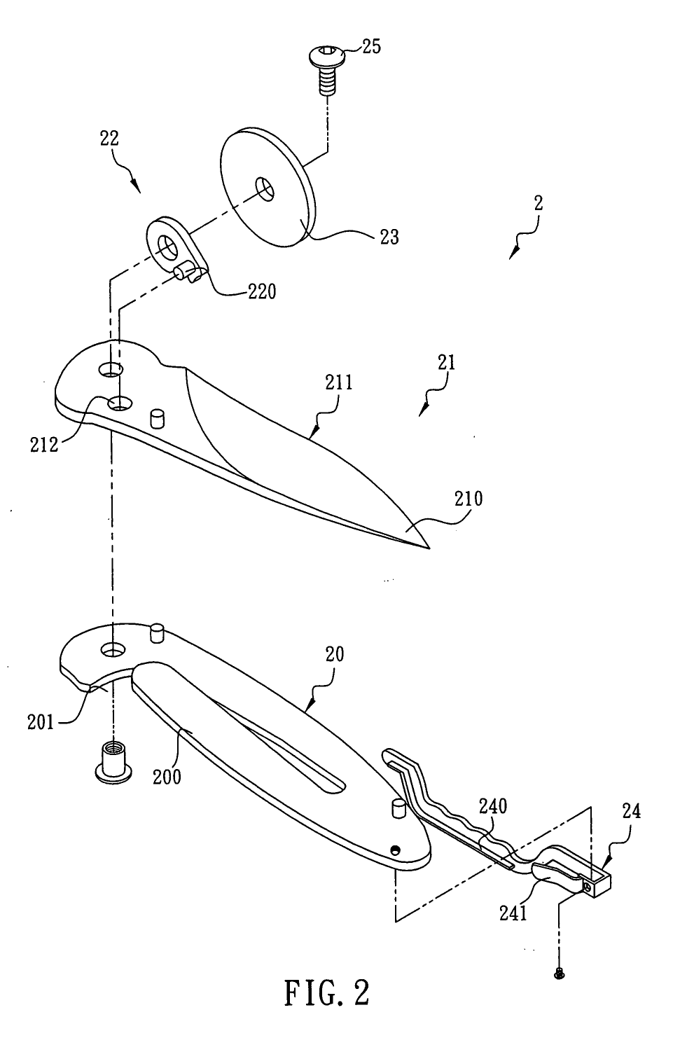

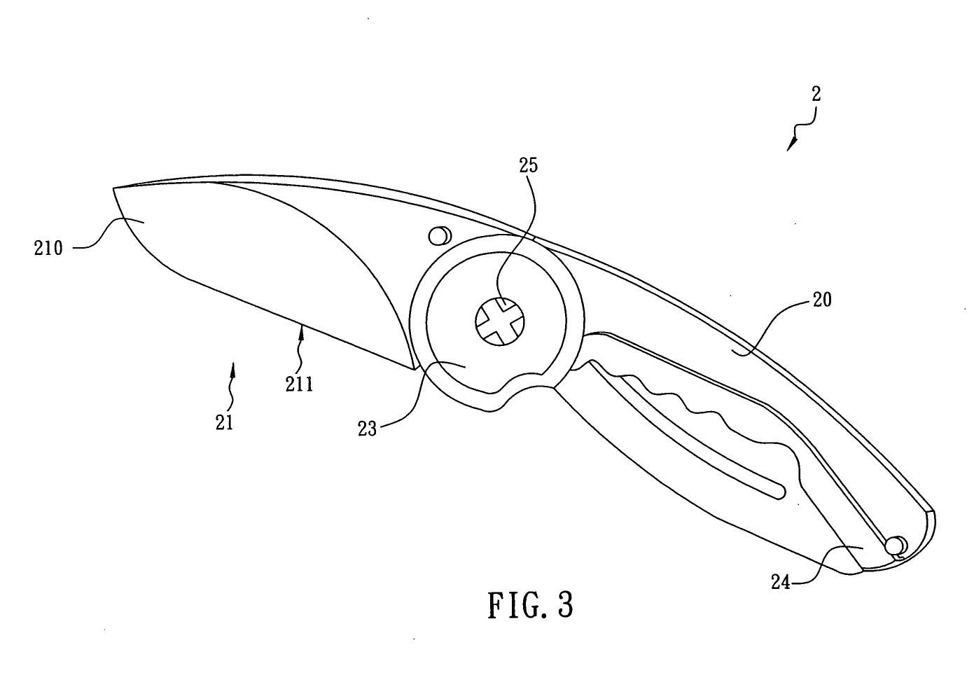

Referring to FIGS. 2 and 3, a folding knife 2 in accordance with a first preferred embodiment of the invention is shown. The folding knife 2 comprises a single, elongate, flat half handle 20. A pivot pin 25 is provided to pivotably secure a front end of the half handle 20 to a rear end of a blade 21 as detailed below. A driven unit 22 is provided proximate to the pivot pin 25 at the rear end of the blade 21. A resilient member 24 is lengthwise provided on the half handle 20. The resilient member 24 is dimensioned and shaped to cooperate with the half handle 20 to allow a cutting edge 211 of the blade 21 to retract therein. The resilient member 24 has a front end urged against the driven unit 22. For ejecting the blade 21 from the half handle 20, a user may manipulate the resilient member 24 to release its stored elastic force to pivot the blade 21 through the driven unit 22. As an end, the blade 21 ejects from the half handle 20. In short, the folding knife 2 is substantially comprised of the assembled blade 21, the driven unit 22, and the resilient member 24. Manipulating the resilient member 24 will retract the blade 21 within the folding knife 2. Manipulating the resilient member 24 in cooperation with the driven unit 22 will eject the blade 21 from the folding knife 2. This has the benefit of greatly reducing the manufacturing cost. Further, the folding knife 2 having a single half handle has a simple construction, is easily produced, and possesses no danger to the body when carrying since the cutting edge 211 cannot be quickly ejected.

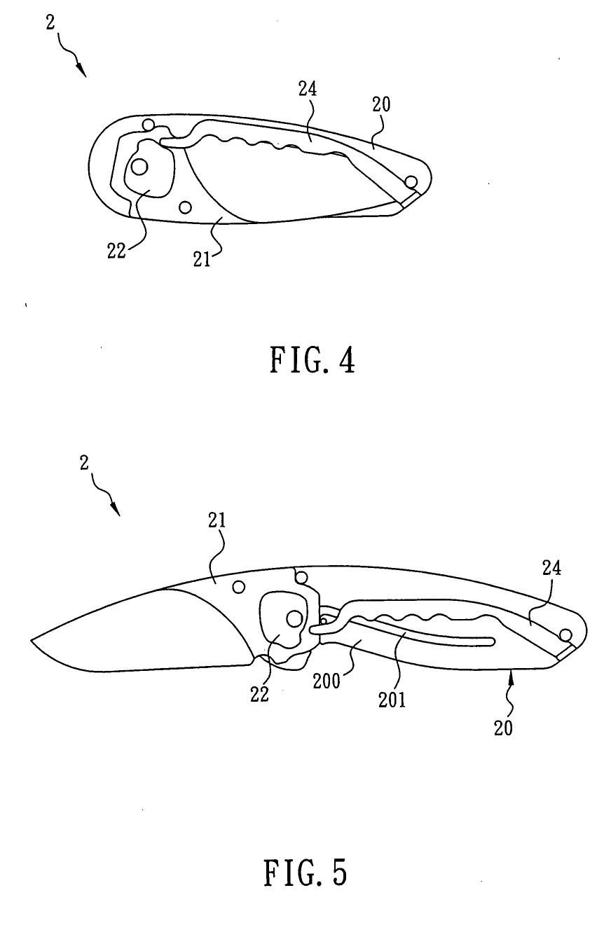

Referring to FIGS. 4 and 5 in conjunction with FIG. 2, in the first preferred embodiment of the invention the rear end of the blade 21, distal a point 210 of the blade 21, is pivotably secured to the front end of the half handle 20. A hole 212 is formed adjacent the pivot pin 25 at the rear end of the blade 21. The driven unit 22 is a flat member. The driven unit 22 comprises a corresponding peg 220 adapted to insert into the hole 212 for securely fixing the driven unit 22 onto the blade 21. Thus, the blade 21 is adapted to pivot relative to the half handle 20. A disc shaped cap 23 having a central hole (not numbered) is provided on the driven unit 22. The pivot pin 25 is adapted to drive through the cap 23 into the driven unit 22 to pivotably secure the cap 23 onto the rear end of the blade 21 by threadably securing to internal threads of a fastener (not numbered). The cap 23 is dimensioned to cover the driven unit 22 and the rear end of the blade 21 for the protection of the driven unit 22 and the rear end of the blade 21. A user may manipulate the resilient member 24 to release its stored elastic force to pivot the blade 21 through the driven unit 22 in use. By configuring as above, both the driven unit 22 and the blade 21 are free from being adversely affected by foreign objects (e.g., the hand) in operation. As an end, no jamming of both the driven unit 22 and the blade 21 can occur and the problem of accidentally cutting the hand by the cutting edge 211 is substantially eliminated.

Referring to FIGS. 2, 4, and 5 again, in the first preferred embodiment a rear end of the resilient member 24 is secured to a rear end of the half handle 20 and the front end thereof extends to abut against the driven unit 22. A receiving space (not numbered) is defined by and between the resilient member 24 and the half handle 20. The space is adapted to receive the cutting edge 211 of the blade 21. An elongate projection 240 projects from one side of the resilient member 24 facing a top surface of the blade 21. The projection 240 extends from a front end of the resilient member 24 to terminate at a rear end of the resilient member 24. Thus, the blade 21 can be retracted into the half handle 20 by cooperating with the resilient member 24. Also, the hand is protected by the projection 240. Otherwise, the hand can be cut by the sharp blade 21. A clip 241 is provided at the rear end of the resilient member 24. The clip 241 extends through the rear end of the half handle 20 to extend onto a bottom surface of the half handle 20 opposite the blade 21. A user may securely hang the clip 241 on the belt or the pocket of the clothes when carrying the folding knife 2.

Referring to FIGS. 2, 4, and 5 again, by configuring as above the front end of the resilient member 24 urges against the periphery of the driven unit 22 when the blade 21 is received in the space. Next, pivot the blade 21 to securely receive in the half handle 20. To the contrary, for ejecting the blade 21 from the half handle 20, a user may oppositely pivot blade 21 to cause the driven unit 22 to move to a predetermined position. Next, the resilient member 24 exerts an elastic force on the blade 21. That is, the resilient member 24 exerts a force to pivot the blade 21 through the driven unit 22. And in turn, the blade 21 pivots due to the secure engagement of the peg 220 with the hole 212. As a result, the blade 21 ejects from the half handle 20. The invention can prevent the blade 21 from being ejected due to vibration or accidental pressing.

Referring to FIGS. 2, 4, and 5 again, in the first preferred embodiment an opening 201 is formed at one side of the half handle 20 proximate to a forward portion thereof. The opening 201 extends toward the rear end of the half handle 20 to form an upwardly inclined latch 200 which extends from the rear end of the half handle 20 to terminate at the mouth of the opening 201. Thus, an end of the latch 200 is adapted to urge against the blade 21. The blade 21 ejected from the space cannot be retracted into the half handle 20 without further manipulation since the blade 21 is stopped by the latch 200. In fact, a user has to press the latch 200 to move the latch 200 from the returning path of the blade 21 and then oppositely pivot the blade 21 prior to retracting the blade 21 into the space for receiving.

Referring to FIG. 2 again, while the peg 220 formed on the driven unit 22 and the hole 212 formed in the blade 21 are described as a preferred embodiment of the invention, it is understood that the peg 220 formed on the blade 21 and the hole 212 formed in the driven unit 22 are equally applicable to other preferred embodiments without departing from the scope of the invention. Moreover, shapes of the peg 220 and the hole 212 other than that described in the first preferred embodiment are also contemplated by the invention as long as they can be matingly secured together for mounting the driven unit 22 on the blade 21.

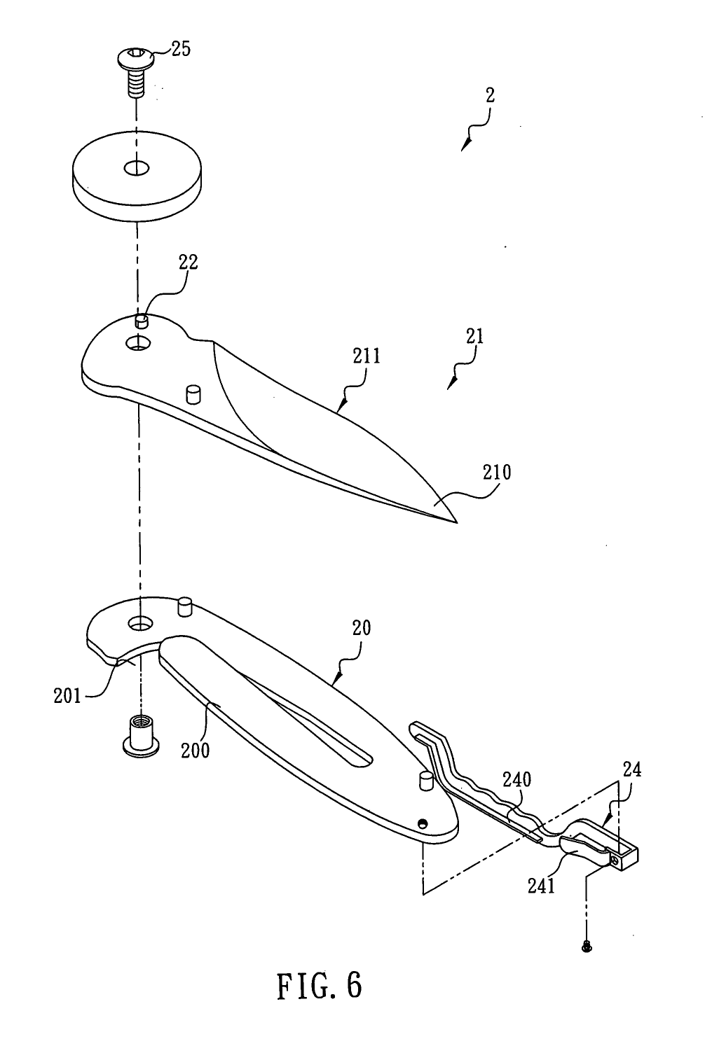

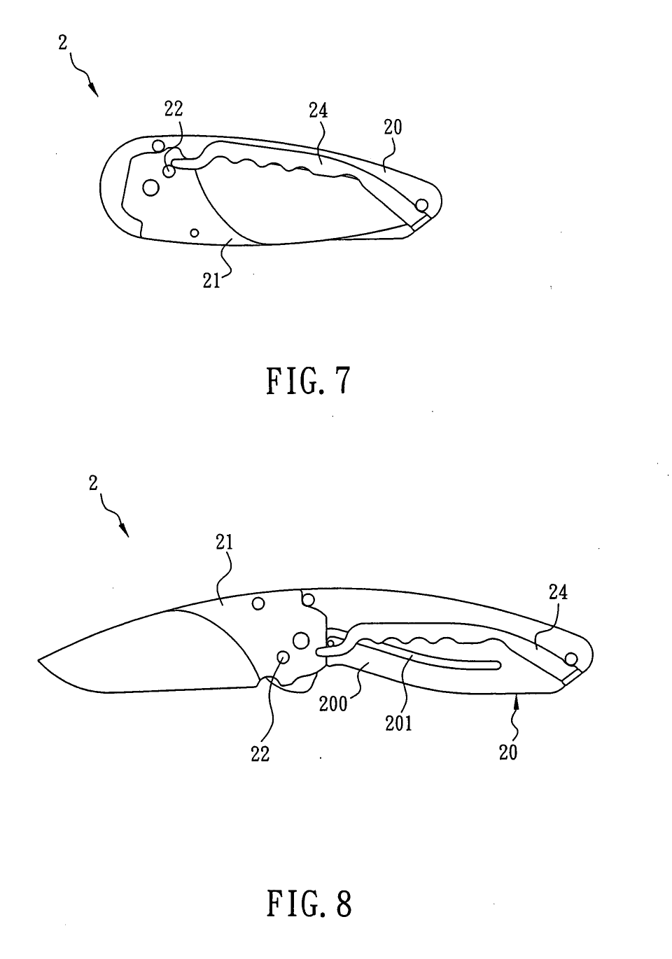

Referring to FIGS. 6, 7, and 8, a second preferred embodiment of the invention is shown. The characteristics of the second preferred embodiment are detailed below. A rear end of the blade 21, distal a point 210 of the blade 21, is pivotably secured to the front end of the half handle 20. A driven unit 22 is provided proximate to a pivot pin 25 at the rear end of the blade 21. The driven unit 22 is implemented as a protrusion 22 securely fixed on the blade 21. A resilient member 24 is adapted to release its stored elastic force to pivot the blade 21 through the driven unit 22. A disc shaped cap 23 having a central hole (not numbered) is provided on the driven unit 22. The pivot pin 25 is adapted to drive through the cap 23 and the driven unit 22 to threadably secure to internal threads of a fastener (not numbered) at the rear end of the blade 21. The cap 23 is dimensioned to cover the driven unit 22 and the rear end of the blade 21 for the protection of the driven unit 22 and the rear end of the blade 21. A user may manipulate the resilient member 24 to release its stored elastic force to pivot the blade 21 through the driven unit 22 in use. By configuring as above, both the driven unit 22 and the blade 21 are free from being adversely affected by foreign objects (e.g., the hand) in operation. As an end, no jamming of both the driven unit 22 and the blade 21 can occur and the problem of accidentally cutting the hand by the cutting edge 211 is substantially eliminated.

Referring to FIGS. 6, 7, and 8 again, in the second preferred embodiment a rear end of the resilient member 24 is secured to a rear end of the half handle 20 and the front end thereof extends to abut against the driven unit 22. A receiving space (not numbered) is defined by and between the resilient member 24 and the half handle 20. The space is adapted to receive the cutting edge 211 of the blade 21. An elongate projection 240 projects from one side of the resilient member 24 facing a top surface of the blade 21. The projection 240 extends from a front end of the resilient member 24 to terminate at a rear end of the resilient member 24. Thus, the blade 21 can be retracted into the half handle 20 by cooperating with the resilient member 24. Also, the hand is protected by the projection 240. Otherwise, the hand can be cut by the sharp blade 21. A clip 241 is provided at the rear end of the resilient member 24. The clip 241 extends through the rear end of the half handle 20 to extend onto a bottom surface of the half handle 20 opposite the blade 21. A user may securely hang the clip 241 on the belt or the pocket of the clothes when carrying the folding knife 2.

Referring to FIGS. 6, 7, and 8 again, by configuring as above the front end of the resilient member 24 urges against the periphery of the driven unit 22 when the blade 21 is received in the space. Next, pivot the blade 21 to securely receive same in the half handle 20. To the contrary, for ejecting the blade 21 from the half handle 20, a user may oppositely pivot the blade 21 outwardly until the blade 21 is disposed at a predetermined position slightly externally of the half handle 20. Next, the resilient member 24 exerts an elastic force on the blade 21 through the driven unit 22. That is, the resilient member 24 exerts a force to pivot the blade 21. As a result, the blade 21 ejects from the half handle 20. The invention can prevent the blade 21 from being ejected due to vibration or accidental pressing.

Referring to FIGS. 6, 7, and 8 again, in the first preferred embodiment an opening 201 is formed at one side of the half handle 20 proximate to a forward portion thereof. The opening 201 extends toward the rear end of the half handle 20 to form an upwardly inclined latch 200 which extends from the rear end of the half handle 20 to terminate at the mouth of the opening 201. Thus, an end of the latch 200 is adapted to urge against the blade 21. The blade 21 ejected from the space cannot be retracted into the half handle 20 without further manipulation since the blade 21 is stopped by the latch 200. In fact, a user has to press the latch 200 to move the latch 200 from the returning path of the blade 21 and then oppositely pivot the blade 21 prior to retracting the blade 21 into the space for receiving.

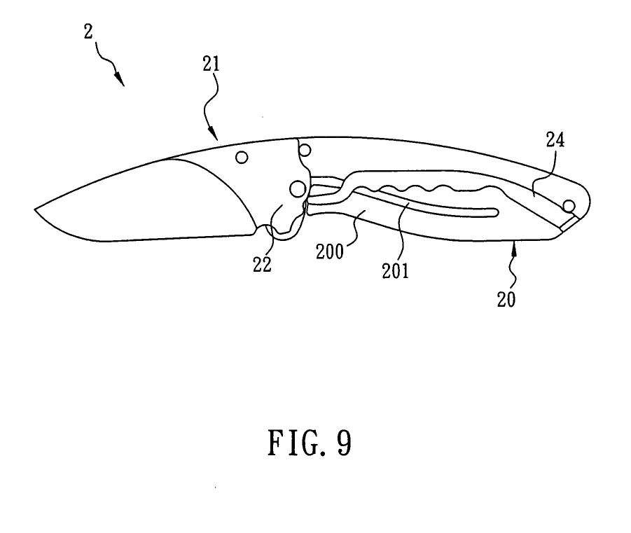

Referring to FIG. 9, a third preferred embodiment of the invention with respect to the blade 21 and the driven unit 22 of the folding knife 2 is shown. The blade 21 has a rear end integrally formed with the driven unit 22. The driven unit 22 also can cooperate with the resilient member 24 to retract the blade 21 into the folding knife 2 or eject the blade 21 from the folding knife 2. While the driven unit 22 and the blade 21 are described as a preferred embodiment of the invention, it is understood that the blade 21 and the driven unit 22 other than that described in the third preferred embodiment are equally applicable to other preferred embodiments without departing from the scope of the invention. Moreover, shape of the driven unit 22 other than that described in the third preferred embodiment is also contemplated by the invention as long as it can cooperate with the resilient member 24 to pivot the blade 21 for retracting the blade 21 into the folding knife 2 or ejecting the blade 21 from the folding knife 2.

While the invention herein disclosed has been described by means of specific embodiments, numerous modifications and variations could be made thereto by those skilled in the art without departing from the scope and spirit of the invention set forth in the claims.

What is claimed is:

1. A folding knife comprising:
an elongate, flat half handle;
a blade having a forward point;
a pivot pin for pivotably securing a rear end of the blade to a front end of the half handle;
a driven unit disposed proximate to the pivot pin at the rear end of the blade; and
a resilient member having a rear end secured to the rear end of the half handle, and a front end extending toward the driven unit to urge against the driven unit, when the blade is retracted into the half handle, for exerting a force to pivot the blade to securely receive the blade in the half handle, or to urge against the driven unit, when the blade is pushed to a predetermined position out of the half handle, for exerting an opposite force to pivot and fully eject the blade from the half handle; and
wherein a receiving space is defined by and between the resilient member and the half handle when the blade is retracted into the half handle, the receiving space being adapted to conceal and receive a cutting edge of the blade.

2. The folding knife of claim 1, wherein the driven unit is a flat member comprising a peg adapted to insert into a hole of the blade proximate to the pivot pin for securely fixing the driven unit onto the blade.

3. The folding knife of claim 1, wherein the driven unit is a flat member comprising a hole adapted to be inserted by a peg of the blade proximate to the pivot pin for securely fixing the driven unit onto the blade.

4. The folding knife of claim 1, wherein the driven unit is a protrusion securely fixed on the blade.

5. The folding knife of claim 2, further comprising an elongate projection projecting from one side of the resilient member facing a top surface of the blade, wherein the projection extends from the front end of the resilient member to terminate at the rear end of the resilient member.

6. The folding knife of claim 3, further comprising an elongate projection projecting from one side of the resilient member facing a top surface of the blade, wherein the projection extends from the front end of the resilient member to terminate at the rear end of the resilient member.

7. The folding knife of claim 4, further comprising an elongate projection projecting from one side of the resilient member facing a top surface of the blade, wherein the projection extends from the front end of the resilient member to terminate at the rear end of the resilient member.

8. The folding knife of claim 5, further comprising a clip disposed at the rear end of the resilient member and extended through the rear end of the half handle to a bottom surface of the half handle opposite the blade.

9. The folding knife of claim 6, further comprising a clip disposed at the rear end of the resilient member and extended through the rear end of the half handle to a bottom surface of the half handle opposite the blade.

10. The folding knife of claim 7, further comprising a clip disposed at the rear end of the resilient member and extended through the rear end of the half handle to a bottom surface of the half handle opposite the blade.

11. The folding knife of claim 5, wherein the half handle comprises an opening at one side proximate to the front end thereof and extending toward the rear end of the half handle, and a bent latch extending from the rear end of the half handle to terminate at a mouth of the opening proximate to the rear end of the blade.

12. The folding knife of claim 6, wherein the half handle comprises an opening at one side proximate to the front end thereof and extending toward the rear end of the half handle, and a bent latch extending from the rear end of the half handle to terminate at a mouth of the opening proximate to the rear end of the blade.

13. The folding knife of claim 7, wherein the half handle comprises an opening at one side proximate to the front end thereof and extending toward the rear end of the half handle, and a bent latch extending from the rear end of the half handle to terminate at a mouth of the opening proximate to the rear end of the blade.

14. The folding knife of claim 5, further comprising a cap having a central hole, whereby the pivot pin is adapted to pivotably secure the cap onto the rear end of the blade through the central hole, and the cap is dimensioned to cover the driven unit and the rear end of the blade.

15. The folding knife of claim 6, further comprising a cap having a central hole, whereby the pivot pin is adapted to pivotably secure the cap onto the rear end of the blade through the central hole, and the cap is dimensioned to cover the driven unit and the rear end of the blade.

16. The folding knife of claim 7, further comprising a cap having a central hole, whereby the pivot pin is adapted to pivotably secure the cap onto the rear end of the blade through the central hole, and the cap is dimensioned to cover the driven unit and the rear end of the blade.
